(19) United States
(12) Patent Application Publication
(10) Pub. No.: US 2006/0239867 A1
(43) Pub. Date: Oct. 26, 2006

(54) Radio frequency identification (RFID) in laboratories

(76) Inventor: Charles Schaeffer, Cincinnati, OH (US)

Correspondence Address: FROST BROWN TODD, LLC, 2200 PNC CENTER, 201 E. FIFTH STREET, CINCINNATI, OH, 45202, US

(21) Appl. No.: 11/396,749

(22) Filed: Apr. 3, 2006

Related U.S. Application Data
(60) Provisional application No. 60/667,244, filed on Apr. 1, 2005.

(51) Int. Cl. B01L 9/00

(52) U.S. Cl. 422/102

(57) ABSTRACT

Radio frequency identification (RFID) is used to identify specimen cassettes for laboratory samples, particularly pathological laboratory samples. Cassettes include RFID tags that provide identifying information, such as accession and block numbers. A method of identifying specimens and specimen cassettes is also provided.

### CROSS REFERENCE TO RELATED APPLICATIONS

This application claims priority from provisional application Ser. No. 60/667,244 filed on Apr. 1, 2005 entitled “RFID IN LABORATORIES”. The present invention relates to a radio frequency identification (RFID) solution for laboratories that perform tests on tissues and specimens using slides. More particularly, it relates to the use of RFID tags on specimen cassettes.

### BACKGROUND OF THE INVENTION

In many pathological laboratories tissues and specimen containers are not continuously controlled, specifically these tissues or specimen containers are not marked with machine-readable identification. This provides an opportunity for the introduction of error in properly identifying the tissues.

In a typical pathological laboratory, technicians must juggle dozens of requisitions and containers with specimens that may be identified only with handwritten instructions, patient information, and long identifying numbers. In a histology laboratory, for example, blocks are cut from a specimen to be processed. These specimen blocks are each affixed to a cassette. The specimens are each given a separate block number, often four digits in length. Depending on the size of the specimen, there may be several cassettes. Each cassette must be identified with the block number for the specimen and an accession number. The typical accession number can be five or six characters long. It can also include a prefix to identify the facility with which it is associated. This facility code may be two or three digits in length. In addition, a date code, often two digits, is usually included. As a result, the accession numbers can include 11 characters and each cassette can have a total of 15 characters associated with it. Technicians must input all of these characters accurately for each cassette they handle.

Technicians can be responsible for dozens of cassettes with specimens ready to be embedded in paraffin, cut on the microtome, stained and diagnosed. At numerous points along the process, each of the accession and block numbers needs to be verified and tracked. In many laboratories, this verification is done manually. In addition to manually inputting the accession number at least twice at the grossing station, technicians are required to type each accession number into a separate computer to print labels for corresponding slides.

### BRIEF SUMMARY OF THE INVENTION

The present invention provides a specimen cassette that includes an RFID tag to identify the specimen that is being sliced. The present invention also provides a method of identifying laboratory specimens comprising the steps of: providing a specimen cassette with a radio frequency identification tag; inserting a specimen into said specimen cassette; providing identifying information about said specimen to said radio frequency identification tag; processing said specimen; attaching said specimen to an outer edge of said specimen cassette; slicing said specimen into a thin layer with a slicing machine; transmitting said identifying information to a printer; transferring the sliced thin layer of specimen to a slide printing a slide label that contains the identifying information

### BRIEF DESCRIPTION OF THE DRAWING

FIG. 1 is a top view of a specimen cassette.

FIG. 2 is a bottom view of a specimen cassette.

FIG. 3 is a view showing an open specimen cassette.

### DETAILED DESCRIPTION OF THE INVENTION

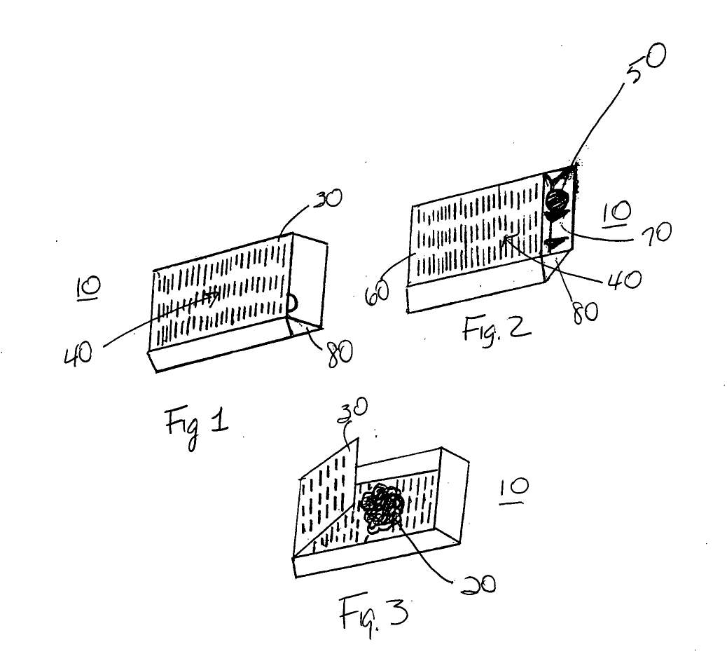

In a typical laboratory, tissue samples and the accompanying paper work enter the “grossing” room in various containers. They are placed into a specimen cassette 10. See FIGS. 1-3. Identifying data related to this sample or specimen is entered into a computer initiating printing of human readable characters, or possibly bar codes in the future, on widely used plastic specimen cassettes to identify the specimen 20. These cassettes 10 have a lid 30 and are made with a “screen” type front and back 40 to allow the various chemicals used to move through the cassette 10 during the preparation process. This preparation process can includes steps such as heating or cooling the specimen 20, or treating it with any number of chemicals, many of them are quite harsh. This subjects the plastic specimen cassette 10 to extreme conditions, such as heat, cold, solvents, etc. It is difficult to affix identifying information to the specimen cassette 10 in such a way that it will survive the preparation process and still be legible. After this preparation process, the specimen 20 is typically attached to the outer surface, typically the bottom surface 60, of the specimen cassette 10 with hot paraffin. The specimen cassette 10 then becomes a base with the specimen 20 being attached in such a manner that it is ready for cutting. The cutting is performed on a machine (such as a Microtome machine) that slices off a thin layer of the specimen 20. This thin layer is soften then placed in a bath and from there it is floated onto a slide. The slide may have been previously labeled with identifying information, including the accession and block numbers, or it may be labeled after the specimen slice is attached to it. It may be labeled with preprinted labels or labeled by hand with a grease pencil, permanent marker, etc.

The present invention provides an RFID specimen cassette 10 and a process of identifying specimen cassettes 10 that ensures the identifying information on the slide is consistent with the information related to the specimen 20 in the specimen cassette 10, among other things.

The specimen 20 is placed into a specimen cassette 10 containing an RFID tag 50. Specimen cassettes 10 are well-known in the art and any specimen cassette 10 can be used with the present invention. The specimen cassettes 10 are typically made of plastic. As described above, the specimen cassette 10 typically has a top 30 and bottom 60 surface that has a screen 30 in it to allow fluids to flow over the specimen 20 inside. It is typically a rectangular box shape, approximately 36 mm long, 28 mm wide, and 6 mm in depth, although any shape and size may be used. It may include an angled portion 80 that allows it to be held by the slicing machine. It may include a recessed area 70 to hold the RFID tag 50.

RFID tags 50 are also well-known in the art. It is preferable to choose an RFID tag 50 that is small enough to fit in or on the specimen cassette 10. The RFID tag 50 allows for machine-readable verification before and after the “preparation process” by a variety of available readers, if desired. These readers are also well-known in the art. Preferably, the RFID tag 50 is a passive RFID tag, rather than an active one, because a passive tag requires no internal battery and thus is typically smaller than an active RFID tag. The RFID tag 50 may be attached to the specimen cassette 10 by any means known in the art, including mechanical locks or clips or adhesives.

The RFID tag 50 in or on the specimen cassette 10 contains the desired identifying information, such as accession and/or block number. An antenna that can querry the RFID tag 50 is attached to or placed on or near the slicing machine that cuts the specimen 20 into thin slices. When the specimen cassette 10 is brought to the slicing machine, the data in the RFID tag 50 is transmitted to the antenna. The antenna sends the collected information onto a printer, preferably via computer, that can then print directly onto slides or onto labels for attachment to the slides. The label in the desired format matching the particular specimen 20 is printed as the slide is readied for use while the specimen cassette 10 is still attached to the slicing machine.

The process of printing the slide by querying the specimen 20 being cut greatly enhances the ability to correctly mark or match a particular slide to the proper gross specimen 20. When the lab procedures allow for only those specimens 20 from the specimen cassette 10 currently attached to the slicing machine to be present in the water bath for placement on a slide, this sequence provides for enhanced security in identification.

In summary, an RFID tag contained in a plastic specimen cassette resolves two important issues. First, it provides a machine readable solution for marking that will withstand the protocols used in the lab. Secondly, it allows the user to positively identify a slide by continually identifying the specimen cassette while the slide is being prepared.

What is claimed is:

1. A specimen cassette comprising a lid, a bottom, and a radio frequency identification tag.

2. A specimen cassette according to claim 1, wherein the radio frequency identification tag is a passive radio frequency identification tag.

3. A method of identifying laboratory specimens comprising the steps of:
providing a specimen cassette with a radio frequency identification tag;
inserting a specimen into said specimen cassette;
providing identifying information about said specimen to said radio frequency identification tag;
processing said specimen;
attaching said specimen to an outer edge of said specimen cassette;
slicing said specimen into a thin layer with a slicing machine;
transmitting said identifying information to a printer;
transferring the sliced thin layer of specimen to a slide;
printing a slide label that contains the identifying information.

4. The method of claim 3, further comprising the step of
ensuring that the specimen cassette is not removed from the slicing machine until the slide label and sliced thin layer of specimen are placed on the slide.
